(19) United States
(12) Patent Application Publication
(10) Pub. No.: US 2025/0219167 A1
(43) Pub. Date: Jul. 3, 2025

(54) CELLS CONTACT SHEETS, CELLS CONTACT SYSTEMS, AND BATTERY PACKS

(71) Applicant: EVE ENERGY CO., LTD., Huizhou (CN)

(72) Inventor: Hulong LIAO, Huizhou (CN)

(73) Assignee: EVE ENERGY CO., LTD., Huizhou (CN)

(21) Appl. No.: 18/991,644

(22) Filed: Dec. 22, 2024

(30) Foreign Application Priority Data
Dec. 31, 2023 (CN) 202323671458.3
Mar. 27, 2024 (WO) PCT/CN2024/084037

(51) Int. Cl. H01M 10/42; H01M 10/48; H01M 50/209; H01M 50/258; H01M 50/507

(52) U.S. Cl. CPC H01M 10/425; H01M 10/482; H01M 50/209; H01M 50/258; H01M 50/507; H01M 2010/4271

(57) ABSTRACT

A cells contact sheet applicable to a battery module including cell groups, the cells contact sheet includes cells contact sub-sheets and at least one connecting sheet. The cells contact sub-sheets are configured to acquire work signals of the cell groups, respectively. The connecting sheet is arranged between every two adjacent ones of the cells contact sub-sheets, and two ends of the connecting sheet are respectively connected with the two adjacent ones of the cells contact sub-sheets. The connecting sheet is provided with a first bending structure configured to deform when two of the cell groups corresponding to the every two adjacent ones of the cells contact sub-sheets move away from each other or close to each other.

### CROSS-REFERENCE TO RELATED APPLICATIONS

This application claims priority to International Application No. PCT/CN2024/084037, filed on Mar. 27, 2024, and Chinese Patent Application No. 202323671458.3, filed on Dec. 31, 2023. The disclosures of the abovementioned applications are incorporated herein by reference in their entireties.

### TECHNICAL FIELD

The present application relates to battery technologies, in particular to cells contact sheets, cells contact systems and battery packs.

### BACKGROUND

Generally, a battery pack includes a housing, a battery module, a battery management system (BMS) board, and a cells contact system (CCS) that electrically connects the battery module with the BMS board. The battery module, the BMS board and the CCS are arranged in the housing. The CCS includes a busbar electrically connected to cells of the battery module and a cells contact sheet electrically connected to the busbar and the cells. The cells contact sheet is usually a flexible printed circuit board (FPCB). The cells contact sheet is used to transmit temperature signals and voltage signals of the cells to the BMS board through a harness and a connector in sequence.

When the battery module includes multiple cell groups, in order to reduce the number of electrical parts and the difficulty of wiring, a cells contact sheet is usually used to acquire the temperature signals and voltage signals of the multiple cell groups. However, during the use of the battery module, a cell may expand due to rising temperature and thus produce tension on the cells contact sheet welded to the cell, so that the weld between the cells contact sheet and the cell may be broken and even the cells contact sheet may be torn. Therefore, the reliability of the acquisition result may be reduced.

### SUMMARY

According to one or more embodiments of the present application, a cells contact sheet applicable to a battery module including a plurality of cell groups is provided. The cells contact sheet includes cells contact sub-sheets and at least one connecting sheet being flexible and electrically conductive, and are configured to acquire work signals of the plurality of cell groups, respectively; each of the at least one connecting sheet is arranged between every two adjacent ones of the cells contact sub-sheets to connect the every two adjacent ones of the cells contact sub-sheets to each other; and the each of the at least one connecting sheet is provided with a first bending structure configured to deform when two of the cell groups respectively corresponding to the every two adjacent ones of the cells contact sub-sheets move away from each other or close to each other.

According to one or more embodiments of the present application, a cells contact system including a holder, multiple busbars, and aforementioned cells contact sheet is provided. The busbars are arranged successively in parallel on the holder, and are configured to be connected with the multiple cell groups, respectively; and multiple cells contact sub-sheets are opposite to and connected with the multiple busbars, respectively.

According to one or more embodiments of the present application, a battery pack includes a housing, a battery module, a BMS board, and at least one of aforementioned cells contact system. The housing is provided with a first accommodating cavity and a second accommodating cavity arranged in a longitudinal direction; the battery module is arranged in the first accommodating cavity and includes multiple cell groups arranged in the longitudinal direction; the BMS board is arranged in the second accommodating cavity; and one of the cells contact sub-sheets is provided with a first signal output terminal connected to the BMS board.

### BRIEF DESCRIPTION OF THE DRAWINGS

FIG. 1 schematically shows a structure of a cells contact sheet according to one or more embodiments of the present application.

FIG. 2 is a side view of a cells contact sheet according to one or more embodiments of the present application.

FIG. 3 is an enlarged view of part A in FIG. 1.

FIG. 4 schematically shows a structure of a cells contact system according to one or more embodiments of the present application.

FIG. 5 is an enlarged view of part B in FIG. 4.

FIG. 6 is an enlarged view of part C in FIG. 4.

FIG. 7 is an enlarged view of part D in FIG. 4.

FIG. 8 schematically shows a structure of a battery pack according to one or more embodiments of the present application.

FIG. 9 schematically shows wiring between a battery charge and discharge interface and a battery energy distribution unit (BDU) of a battery pack according to one or more embodiments of the present application.

FIG. 10 schematically shows wiring of an acquisition harness of a battery pack according to one or more embodiments of the present application.

### DETAILED DESCRIPTION

Some embodiments of the present application will be described in detail below with reference to the accompanying drawings. The embodiments are described for illustrative purposes only and are not intended to limit the present application.

In the description of the present application, unless otherwise expressly specified and limited, the terms “connected”, “connect”, “fixed” should be understood broadly, for example, It would be fixed connection, detachable connection, or may be integrated; It would be a mechanical connection or an electrical connection; It would be directly connected, or indirectly connected through an intermediate medium, it would be the connection within the two components or the interaction between the two components. For persons of ordinary skill in the art, the specific meaning of the above terms in the present application may be understood on a case-by-case basis.

In this application, unless otherwise expressly specified and limited, a first feature being “above” or “below” a second feature would comprise direct contact between the first and second features, or would comprise contact between the first and second features not directly but through another feature between them. Furthermore, the first feature being “on top of”, “over” and “above” the second feature comprise the first feature directly above and diagonally above the second feature, or merely indicate that the horizontal height of the first feature is more than that of the second feature. The first feature being “below”, “beneath” and “under” the second feature comprise the first feature being directly below and diagonally below the second feature, or merely indicate that the horizontal height of the first feature is less than that of the second feature.

In the description of the embodiments, the terms “up”, “down”, “right”, and such orientation or position relation are based on the orientation or position relation shown in the accompanying drawings only for the purpose of facilitating description and simplifying operation, and not to indicate or imply that the device or element referred to must have a particular orientation, be constructed and operated in a particular orientation, and therefore shall not be construed as a limitation of the present application. In addition, the terms “first” and “second” are used only as descriptive distinctions and have no special meaning.

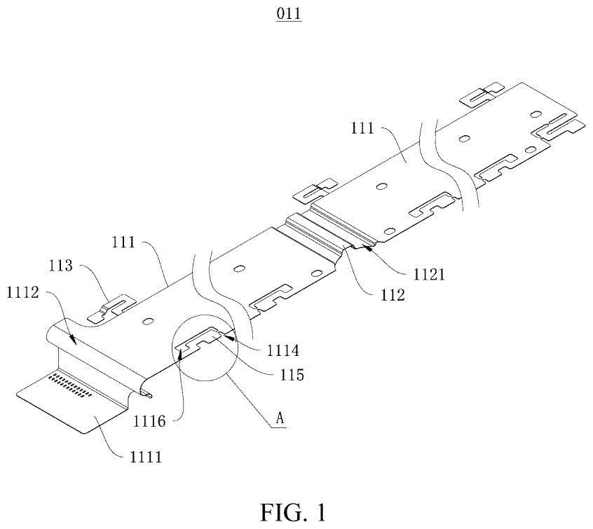

FIG. 1 schematically shows a structure of a cells contact sheet 011 applicable to a battery module according to one or more embodiments of the present application. For example, the battery module includes two cell groups. The cells contact sheet 011 includes two cells contact sub-sheets 111 and a flexible conductive connecting sheet 112. The two cells contact sub-sheets 111 are arranged successively in parallel. The two cells contact sub-sheets 111 are configured respectively to acquire work signals of the two cell groups. The connecting sheet 112 is arranged between the two cells contact sub-sheets 111. The two ends of the connecting sheet 112 are respectively connected with the two cells contact sub-sheets 111, and the connecting sheet 112 is provided with a first bending structure 1121, which is configured to deform when the two cell groups move away from or close to each other.

It can be understood that when the two cell groups move away from each other or close to each other, the first bending structure 1121 will undergo flexible deformation due to the flexibility of the connecting sheet 112. When the connecting sheet 112 is an elastic metal sheet, the first bending structure 1121 also has an elastic deformation. Among them, the work signals are mainly voltage signals of the cells and temperature signals of the cell groups.

In addition, the cells contact sub-sheet 111 has a voltage acquisition area 1113, the voltage acquisition area 1113 is connected with a busbar 131, and the busbar 131 is connected with the cell, so as to realize the cells contact sub-sheet 111 acquiring the voltage signal of the cell. The cell group includes a plurality of cells connected in series or in parallel through the busbar 131.

Illustratively, the cells contact sub-sheet 111 and the connecting sheet 112 are both flexible circuit boards, and the cells contact sheet 011 is an integrally-formed part. The flexible circuit board is a structure formed by etching aluminium foil or copper foil in one body to have a number of lines for transmitting electrical signals.

In the present embodiment, by arranging a first bending structure 1121 at the part of the cells contact sheet 011 between the two cell groups, the cells contact sheet is provided with a buffer part formed based on the first bending structure 1121, in this way, when the cell groups produce thermal expansion, the buffer part can be deformed to buffer the expansion between the cell groups to pull the cells contact sheet 011, and then improve the stability of the welding part between the cells contact sheet 11 and the cells, and avoid the cells contact sheet 011 being torn, and finally improve the reliability of the cells contact sheet 011.

In addition, there are assembly tolerances between the cell groups and the housing 002. Therefore, when assembling the cell groups to the housing 002, the first bending structure 1121 can be squeezed or stretched to make the two cells contact sub-sheets 111 fit the assembly position of the cell groups, so as to improve the pulling or squeezing at the connection part between the cells contact sheet 011 and the cell groups due to assembly errors, and thus improve the reliability of the connection between the cells contact sheet 011 and the cell groups.

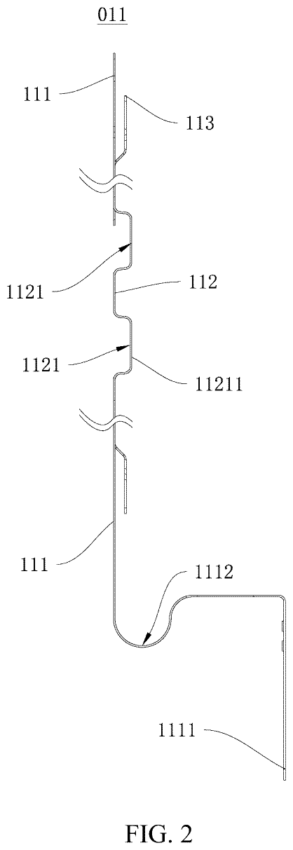

FIG. 2 shows the side view of the cells contact sheet 011 according to one or more embodiments of the present application. In one or more embodiments, the connecting sheet 112 includes a sheet body and a first bending structure 1121, and the first bending structure 1121 is convex to the cell groups from the location of the sheet body of the connecting sheet 112.

It can be understood that a busbar 131 is arranged between the cells contact sheet 111 and the cells, and the voltage acquisition area 1113 of the cells contact sheet 011 is welded with the busbar 131 to acquire the voltage information of the cells. The first bending structure 1121 is not used for acquiring voltage signals, so on the side of the bending structure 1121 facing the cell group is the holder 012.

Based on this, in the present embodiment, the first bending structure 1121 is convex towards the cell group from the location of the sheet body of the connecting sheet 112, so that the cells contact sheet 011 can have a structure for buffering the pulling or squeezing of the cells contact sheet 011, and the first bending structure 1121 is overlapped with the busbar 131 on the axis of the cells, thus, avoiding the arranging of the first bending structure 1121 increases the height of the cells contact system 001, which is conducive to the layout of the electrical parts inside the battery pack.

In one or more embodiments, the first bending structure 1121 shown in FIG. 2 has a first surface 11211 located in the middle of the first bending structure 1121 and toward the cell groups. The first surface 11211 is parallel to the cells contact sub-sheet 111.

It can be understood that the first bending structure 1121 is a U-shaped structure convex to the cell groups, where the side of the part facing the cell groups is the first surface 11211. In particular, the connecting sheet 112 includes two extension segments and a first bending structure 1121 located between the two extension segments. The two extension segments are respectively connected with two cells contact sub-sheets 111. The first bending structure 1121 includes a first bending segment, a second bending segment and a third bending segment successively connected. The first bending segment and the third bending segment are arranged relative to each other. The ends of the first bending segment and the third bending segment deviated from the second bending segment are connected to the two extension segments respectively. The first surface 11211 is on the side of the second bending segment facing the cell group.

In the present embodiment, through the above arranging, the first bending structure 1121 has a longer length in a certain space, so that the first bending structure 1121 has a larger buffer size, and then the first bending structure 1121 can achieve a better buffer effect in a limited space.

In one or more embodiments, the corners of the first bending structure 1121 shown in FIG. 2 are rounded.

It is understood that the joint between one extension segment and the first bending segment, the joint between the first bending segment and the second bending segment, the joint between the second bending segment and the third bending segment, and the joint between the third bending segment and another extension segment are corners. Rounded corners are provided at each of the above joints. The rounded corners are formed by bending the connecting sheet 112.

In the present embodiment, by providing a rounded corner at the corner of the first bending structure 1121, the stress at the corner can be reduced, thereby improving the impact resistance of the cells contact sheet 011 and thereby improving the reliability of the cells contact sheet 011.

In one or more embodiments, one of the two cells contact sub-sheets 111 shown in FIG. 2 is the output cells contact sub-sheet 111. The output cells contact sub-sheet 111 has a first signal output terminal 1111. The output cells contact sub-sheet 111 is provided with a second bending structure 1112, and the second bending structure 1112 is arranged near the first signal output terminal 1111. The second bending structure 1112 is configured to deform when the first signal output terminal 1111 and the cell groups move away from or close to each other.

It is understood that the first signal output terminal 1111 is connected to the BMS board. Generally, the first signal output terminal 1111 is connected with the BMS board via a connector 063 to transmit the acquired work signals to the BMS board. In addition, among the two cells contact sub-sheets 111, the cells contact sub-sheet 111 closer to the BMS board is the output cells contact sub-sheet 111, and the end of the output cells contact sub-sheet 111 near the BMS board is the first signal output terminal 1111.

Since the first signal output terminal 1111 is connected to the BMS board, the first signal output terminal 1111 is fixed. When the cells generate thermal expansion, it will pull on the joint between the first signal output terminal 1111 and the BMS board. Based on this, in the present embodiment, a second bending structure 1112 is provided at one end of the output cells contact sub-sheet 111 near the first signal output terminal 1111, so that the end of the output cells contact sub-sheet 111 near the first signal output terminal 1111 is provided with a structure for buffering the pulling of the first signal output terminal 1111 when the cell groups expand. Thus, the reliability of the connection between the cells contact sheet 011 and the BMS board is improved, and the cells contact sheet 011 is prevented from being torn.

In one or more embodiments, the second bending structure 1112 shown in FIG. 2 is an arc structure with concave surface away from the first signal output terminal 1111.

Illustratively, the side of the second bending structure 1112 away from the first signal output terminal 1111 is tangent to the side of the cells contact sub-sheet 111 located at the second bending structure 1112 away from the first signal output terminal 1111.

In the present embodiment, by arranging the second bending structure 1112 as an arc structure, the stress of the second bending structure 1112 can be reduced, thereby improving the impact resistance of the cells contact sheet 011 and thereby improving the reliability of the cells contact sheet 011.

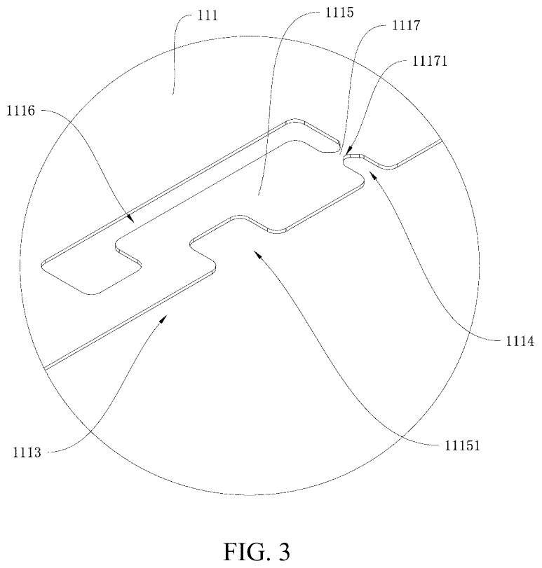

FIG. 3 is an enlarged view of part A in FIG. 1. In one or more embodiments, the cells contact sub-sheet 111 has a voltage acquisition area 1113. The voltage acquisition area 1113 is provided with an acquisition notch 1114. An acquisition terminal sheet 1115 which is configured to acquire the voltage of the cell group is provided in the acquisition notch 1114. The acquisition terminal sheet 1115 has a first end and a second end opposite to each other, and the first end is connected with one surface of the acquisition notch 1114. The second end is connected with another surface of the acquisition notch 114. From the first end to the second end, there is a gap 1116 between the acquisition terminal sheet 1115 and the acquisition notch 1114.

It can be understood that the voltage acquisition area 1113 is the area on the cells contact sub-sheet 111 connected with the busbar 131. Specifically, the acquisition terminal sheet 1115 is welded with the busbar 131 to acquire the voltage information of the cell.

In the present embodiment, through the above arranging, on the one hand, the cells contact sub-sheet 111 can acquire the voltage information of the cells; on the other hand, when the cells expands, the pulling force on the acquisition terminal sheet 1115 is mainly applicable to the first and second ends of the acquisition terminal sheet 1115, thus reducing the pulling force borne by the acquisition terminal sheet 1115, and then avoiding the weld between the acquisition terminal sheet 1115 and the busbar 131 falling off. The stability of the connection between the acquisition terminal sheet 1115 and the busbar 131 can be improved.

As shown in FIG. 3, in one or more embodiments, the second end of the acquisition terminal sheet 1115 is connected with another surface of the acquisition notch 1114 through a connection structure, and the connection structure is configured to break when the cells contact sub-sheet 111 is pulled.

It is understood that the pulling force of disconnecting the connection structure is less than that of disconnecting the connection between the acquisition terminal sheet 1115 and the busbar 131. In addition, the connecting structure fixed the acquisition terminal sheet 1115 in the acquisition notch 1114, which can avoid the second end of the acquisition terminal sheet 1115 falling down due to gravity and cause folding, so as to ensure the convenience of the assembly of the cells contact sheet.

In the present embodiment, by connecting the second end of the acquisition terminal sheet 1115 with the surface of the acquisition notch 1114 through the connection structure, when the acquisition terminal sheet 1115 bearing relatively large pulling force, the connection structure at one end of the acquisition terminal sheet 1115 can be disconnected through the pulling force to reduce the pulling force borne by the acquisition terminal sheet 1115. Thus, the weld between the acquisition terminal sheet 1115 and busbar 131 can be avoided from falling off, and the stability of the connection between the acquisition terminal sheet 1115 and busbar 131 can be improved.

The connection structure may adopt a structure thinner than the acquisition terminal sheet 1115, or a material with lower strength than the joint between the first end of the acquisition terminal sheet 1115 and the acquisition notch 1114. In particular, the connection structure includes a connection strip 1117. The two ends of the connection strip 1117 are respectively connected with the second end of the acquisition terminal sheet 1115 and a surface of the acquisition notch 1114. The middle part of the connection strip 1117 is provided with a cutting notch 11171. The cutting notch 11171 is configured to cause the connection strip 1117 to break when the cells contact sub-sheet 111 is pulled.

In one or more embodiments, the acquisition terminal sheet 1115 shown in FIG. 3 is provided with a buffer notch 11151. The buffer notch 11151 is arranged between the first end of the acquisition terminal sheet 1115 and the second end of the acquisition terminal sheet 1115.

In the present embodiment, the stress of the acquisition terminal sheet 1115 during thermal expansion can be alleviated by arranging the buffer notch 11151, thereby improving the stability of the connection between the acquisition terminal sheet 1115 and the busbar 131.

In one or more embodiments, the edge of the cells contact sub-sheet 111 shown in FIG. 1 is connected with a bent terminal sheet 113 configured to acquire the temperature of the cell group.

It is understood that the bent terminal sheet 113 is located at the outer edge of the cells contact sub-sheet 111 and formed in one piece with the cells contact sub-sheet 111.

In the present embodiment, by using the bent terminal sheet 113 to acquire the temperature information of the cell group, the deformability of the bent terminal sheet 113 can be used to buffer the pulling of the cells contact sheet 011 by the thermal expansion of the cells, thereby improving the load bearing capacity of the cells contact sheet 011, and thereby preventing the cells contact sheet 011 from being torn or the disconnection between the bent terminal sheet 113 and the cells contact sub-sheet 111. Thus, the reliability of the cells contact sheet 011 can be improved.

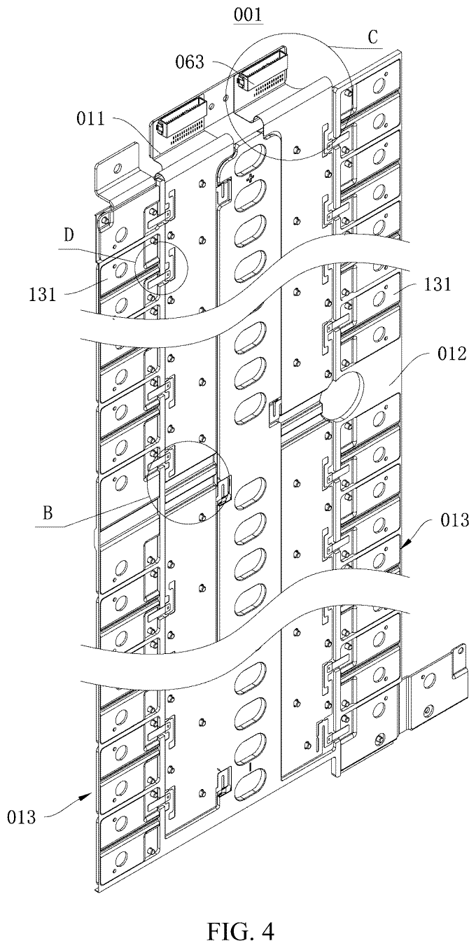

FIG. 4 schematically shows the structure of the cells contact system 001 according to one or more embodiments of the present application. Accordingly, a cells contact system 001 is provided in embodiments of the present application. The cells contact system 001 includes a holder 012, busbar groups 013 and the aforementioned cells contact sheet 011. The busbar groups 013 include two busbar groups 013. The two busbar groups 013 are arranged successively on the holder 012. The two busbar groups 013 are configured to respectively connect with the two cell groups. Two cells contact sub-sheets 111 are connected to the two busbar groups 013 respectively. The connecting sheet 112 is located between the two adjacent busbar groups 013.

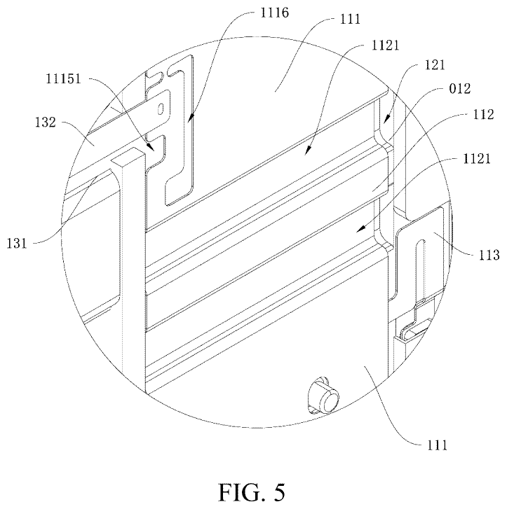

Illustratively, there are two first bending structures 1121 arranged at intervals along the arranging direction of the two cells contact sub-sheets 111. The first bending structure 1121 is convex from the position of the sheet body of the connecting sheet 112 towards the cell groups. The cells contact sub-sheet 111 is arranged on the holder 012. Groove 121 is provided on the holder 012. There are two grooves 121. The two first bending structures 1121 are located in the two grooves 121 respectively, as shown in FIG. 5, which is an enlarged view of part B in FIG. 4. The first bending structure 1121 is fitted with gap 1116 of the groove 121. The gap 1116 between the first bending structure 1121 and the groove 121 is used to provide deformation space for a first bend of the first bending structure 1121, so that the deformation of the first bend of first bending structure 1121 is not hindered.

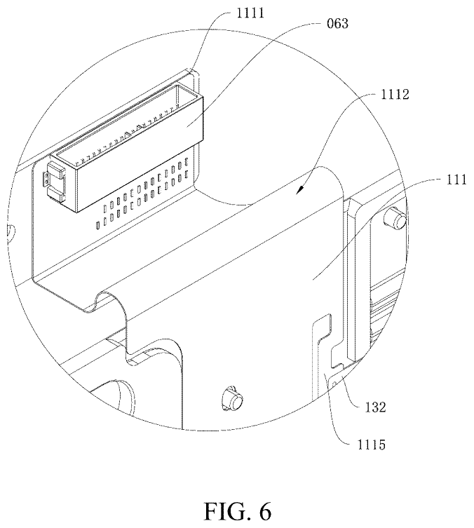

In addition, the concave surface of the second bending structure 1112 faces the end face of the holder 012, as shown in FIG. 6, which is an enlarged view of part C in FIG. 4.

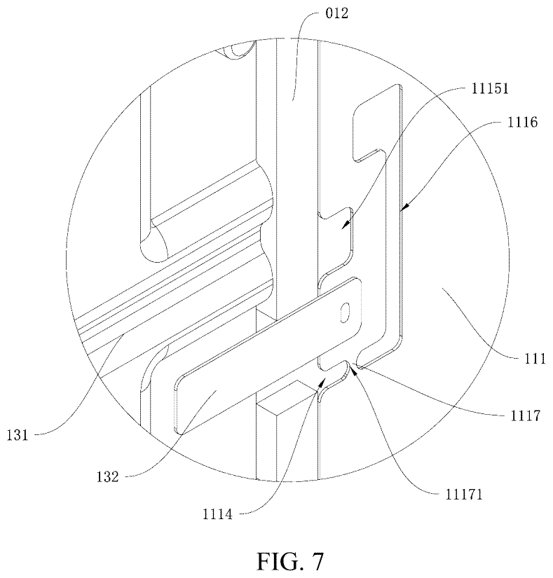

Among them, the holder 012 is a blister holder. Busbar groups 013 include a plurality of busbars 131, which is used to parallel two adjacent cells. Accordingly, a plurality of voltage acquisition areas 1113 are arranged on the cells contact sub-sheets 111, and the plurality of voltage acquisition areas 1113 are respectively connected with the plurality of busbars 131. Busbar 131 is an O-state aluminium bar. Busbar 131 is welded to the pole of the cell. The connection structure between the busbar 131 and cells contact sub-sheet 111 is shown in FIG. 7, which is an enlarged view of part D in FIG. 4. The voltage acquisition area 1113 of the cells contact sub-sheet 111 is connected to the busbar 131 through the conductive sheet 132. In particular, one end of the conductive sheet 132 is welded to the part of the acquisition terminal sheet 1115 between the buffer notch 11151 and the second end of the acquisition terminal sheet 1115, and the other end is welded to the end of the busbar 131 near the cells contact sub-sheet 111.

In the present embodiment, by adopting the aforementioned cells contact sheet 011, the first bending structure 1121 can be used to generate deformation during thermal expansion of the cell groups to buffer the pull of the expansion between the cell groups on the cells contact sheet 011, thereby improving the stability of the welding part between the cells contact sheet 011 and the cells, and avoiding the tearing of the cells contact sheet 011, finally improving the reliability of the cells contact system 001.

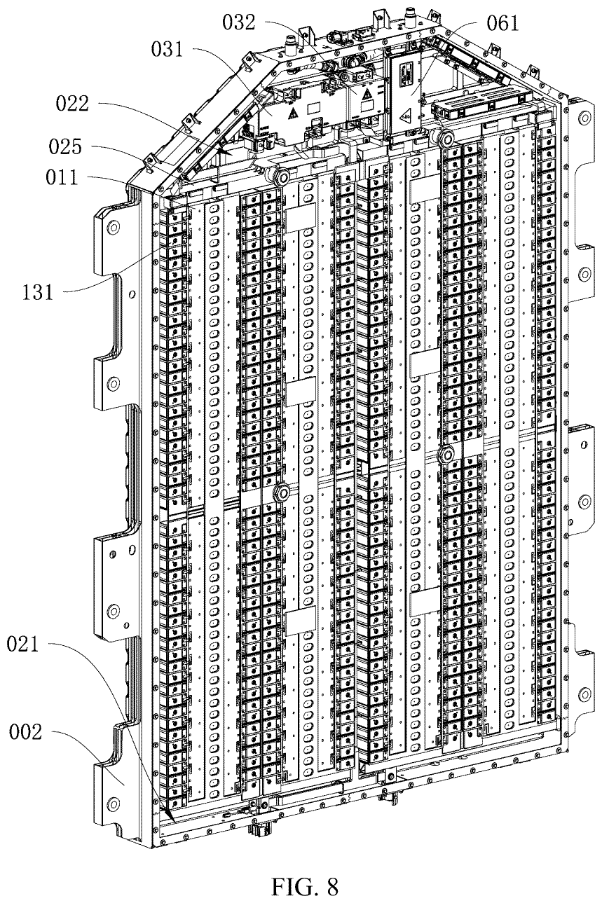

FIG. 8 schematically shows a structure of a battery pack according to one or more embodiments of the present application (the cover of housing 002 is hidden in FIG. 8 for ease of showing the internal structure of the housing). Accordingly, one or more embodiments of the present application further provide a battery pack including a housing 002, a battery module 008, a BMS board and the aforementioned cells contact system 001. The housing 002 has a first accommodating cavity 021 and a second accommodating cavity 022 arranged in a longitudinal direction. The battery module 008 is arranged in the first accommodating cavity 021. The battery module 008 includes two cell groups 081 arranged in the longitudinal direction. The BMS board is arranged in the second accommodating cavity 022. The cells contact system 001 is arranged in the first accommodating cavity 021. Two busbars 131 are connected with two cell groups 081 respectively. Among the two cells contact sub-sheets 111, one is the output cells contact sub-sheet 111. The first signal output terminal 1111 of the output cells contact sub-sheet 111 is connected to the BMS board. Specifically, the first signal output terminal 1111 is connected to the BMS board via connector 063.

Illustratively, the first accommodating cavity 021 and the second accommodating cavity 022 are formed by separating the inner cavity of the battery pack between via an end partition 025. In addition, a cross beam 023 is arranged in the first accommodating cavity 021. The cross beam 023 is connected with the cavity wall of the first accommodating cavity 021. The cross beam 023 is located between the two cell groups 081 of battery module 008 to separate the two cell groups 081.

In the present embodiment, by adopting the cells contact system 001 mentioned above, during thermal expansion of cell groups 081, the deformation of the first bending structure 1121 can be generated to buffer the pull of the expansion between cell groups 081 on the cells contact sheet 011, thereby improving the stability of the welding part between the cells contact sheet 011 and the cells, and avoiding the tearing of the cells contact sheet 011, finally improving the reliability of the battery pack.

As shown in FIG. 8, in one or more embodiments, there are four battery modules 008 and four cells contact systems 001. The four battery modules 008 are arranged along a transverse direction in the first accommodating cavity 021. The transverse direction is perpendicular to the longitudinal direction. The four battery modules 008 and the four cells contact systems 001 are arranged according to a one-to-one correspondence. In order to improve the assembling stability of battery modules 008, a longitudinal beam 024 is arranged between two adjacent battery modules 008, and the longitudinal beam 024 is connected with the inner wall of housing 002.

It can be understood that there are eight cell groups 081 corresponding to four battery modules 008. The eight cell groups 081 are connected in series through O-state aluminium bars.

As shown in FIG. 8, in one or more embodiments, the battery pack further includes a battery energy distribution device (for example, a battery energy distribution unit (BDU)), a battery charge and discharge interface, and a charge and discharge connection bar. The BDU is arranged in the second accommodating cavity 022, the battery charge and discharge interface is arranged on the side of the housing 002 away from the second accommodating cavity 022, two ends of the charge and discharge connection bar are connected with the BDU and the battery charge and discharge interface respectively, and the charge and discharge connection bar is arranged on the end of the longitudinal beam 024 away from the inner wall of the housing 002.

Illustratively, the charge and discharge connection bar includes a middle bar and end bars, and the end bars include two end bars, an end bar connects the end of the middle bar with the BDU, and the other end bar connects the other end of the middle bar with the battery charge and discharge interface, and the end bars are soft metal bars. The middle bar is a 6-series aluminium bar, and the end bars are specifically copper bars. The end bars and the middle bar are welded together by polymer diffusion welding. The soft copper bar can be deformed during assembling to effectively absorb assembly tolerances, thus improving the convenience of connecting the charge and discharge connection bar to the BDU and the battery charge and discharge interface. At the same time, the soft copper bar can better absorb the pulling force caused by the vibration of the vehicle during driving, and avoid disconnection of the high voltage circuit or leakage due to the tension of the charge and discharge connection bar.

In addition, the battery pack is also equipped with a fast charge interface 071. The fast charge interface 071 is located on the side of the battery pack near the BDU.

In the conventional assembling mode, the charge and discharge connection bar is arranged on the wall of the housing 002. The charge and discharge connection bar needs to retain a safe distance from the busbar 131 and the cells, so the first inner cavity needs to have enough space in the longitudinal direction to meet requirements of the installation of relevant parts, and also needs to meet requirements of the safety spacing between the aforementioned parts.

Based on this, in the present embodiment, the charge and discharge connection bar is arranged on the longitudinal beam 024. On the one hand, the space occupied by the longitudinal beam 024 can be utilized, so that the required installation space of the charge and discharge connection bar can be overlapped with the space of the longitudinal beam 024, and the utilization rate of the internal space of the battery pack can be improved. Thus, the original space for arranging the charge and discharge connection bar can be used to increase the transverse size of the cells, so as to improve the energy density of the battery pack. On the other hand, the charge and discharge connection bar is set on the longitudinal beam 024, which can avoid the outer wall of the battery pack being squeezed and cause the insulation layer of the charge and discharge connection bar to break, so as to improve the reliability of the battery pack.

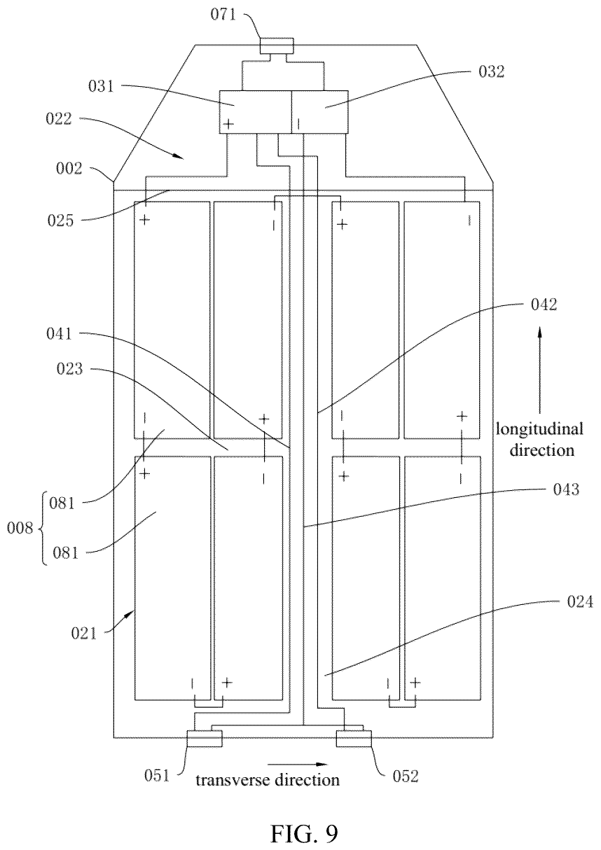

FIG. 9 schematically shows wiring between a battery charge and discharge interface and a BDU of a battery pack according to one or more embodiments of the present application. In one or more embodiments, the battery charge and discharge interface includes charge interface 051 and discharge interface 052. The charge and discharge connection bar includes a charge positive bar 041, a discharge positive bar 042 and a charge and discharge negative bar 043. The positive port of charge interface 051 is connected to the positive port 031 of the BDU through charge positive bar 041. The positive port of the discharge interface 052 is connected to the positive port 031 of the BDU via the discharge positive bar 042. One end of the charge and discharge negative bar 043 is connected to the negative port of the charge interface 051 and the negative port of the discharge interface 052, and the other end is connected to the negative port 032 of the BDU.

In FIG. 9, from left to right, the three long solid lines in the middle are the charge positive bar 041, the charge and discharge negative bar 043, and the discharge positive bar 042 in sequence.

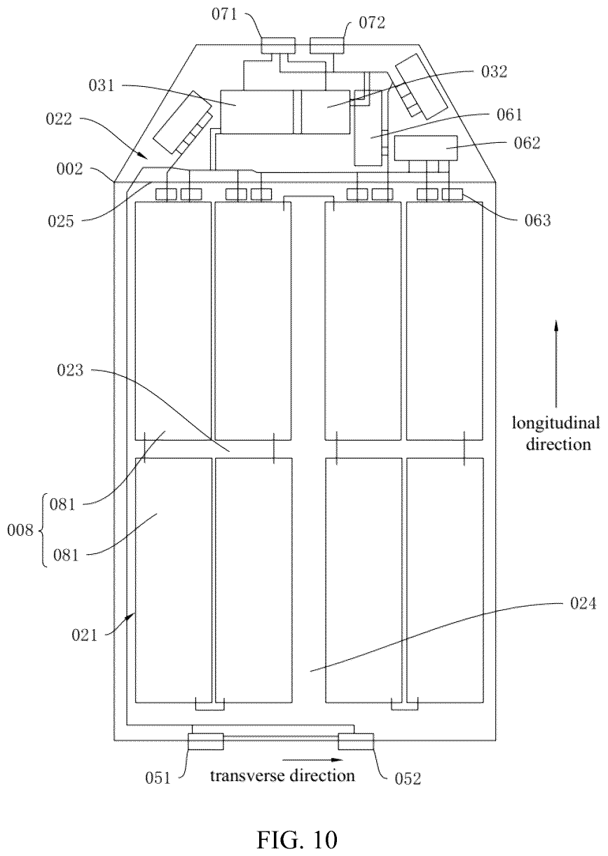

FIG. 10 schematically shows wiring of harnesses for part of acquisition signals of a battery pack according to one or more embodiments of the present application. The BMS board includes the BMS main board 061 and three BMS slave boards 062.

It is understood that the battery pack includes four battery modules 008. And each battery module 008 includes two cell groups 081. The two battery modules 081 include of 25 cells and 26 cells respectively. Therefore, the signal source is too many, and only one BMS main board 061 is not conducive to data processing. Based on this, the BMS board is set as one BMS main board 061 and three BMS slave board 062, which can improve the data processing efficiency, and then improve the reliability of the signal acquisition of the battery pack. Specifically, the BMS slave board 062 transforms the analog signals from the cells contact sheet 011 into a digital signal, and transmits the digital signals to the BMS main board 061 through the daisy chain, and the BMS main board 061 is connected to the control system of the vehicle through the communication interface 072.

Some embodiments of the present application have been described in detail above. The description of the above embodiments merely aims to help to understand the present application. Many modifications or equivalent substitutions with respect to the embodiments may occur to those of ordinary skill in the art based on the present application. Thus, these modifications or equivalent substitutions shall fall within the scope of the present application.

What is claimed is:

1. A cells contact sheet, applicable to a battery module comprising a plurality of cell groups, the cells contact sheet comprising:
a plurality of cells contact sub-sheets configured to acquire work signals of the plurality of cell groups, respectively; and
at least one connecting sheet being flexible and electrically conductive,
wherein each of the at least one connecting sheet is arranged between every two adjacent ones of the cells contact sub-sheets to connect the every two adjacent ones of the cells contact sub-sheets to each other; and
the each of the at least one connecting sheet is provided with a first bending structure configured to deform when two of the cell groups respectively corresponding to the every two adjacent ones of the cells contact sub-sheets move away from each other or close to each other.

2. The cells contact sheet according to claim 1, wherein the each of the at least one connecting sheet further comprises a sheet body, and the first bending structure protrudes, relatively to the sheet body, toward the two of the cell groups.

3. The cells contact sheet according to claim 2, wherein the first bending structure has a first surface, and the first surface is in a middle of the first bending structure and faces the two of the cell groups; and
the first surface is parallel to each of the cells contact sub-sheets.

4. The cells contact sheet according to claim 3, wherein each corner of the first bending structure is rounded.

5. The cells contact sheet according to claim 1, wherein one of the cells contact sub-sheets is provided with a first signal output terminal and a second bending structure close to the first signal output terminal; and
the second bending structure is configured to deform when the first signal output terminal and two of the cell groups corresponding to the one of the cells contact sub-sheets move away from each other or close to each other.

6. The cells contact sheet according to claim 5, wherein the second bending structure comprises an arc-shaped structure having a concave side away from the first signal output terminal.

7. The cells contact sheet according to claim 1, wherein each of the cells contact sub-sheets has a voltage acquisition area comprising an acquisition notch;
an acquisition terminal sheet is arranged in the acquisition notch to acquire a voltage signal of one of the cell groups corresponding to the each of the cells contact sub-sheets;
the acquisition terminal sheet has a first end connected with a first side surface of the acquisition notch, and a second end being opposite to the first end and connected with a second side surface of the acquisition notch; and
a gap extending in a direction from the first end to the second end is formed between the acquisition terminal sheet and the acquisition notch.

8. The cells contact sheet according to claim 7, wherein the second end of the acquisition terminal sheet is connected with the second side surface of the acquisition notch through a connection structure, and the connection structure is configured to break when the each of the cells contact sub-sheets is pulled.

9. The cells contact sheet according to claim 8, wherein the connection structure comprise a connection strip having two ends respectively connected with the second end of the acquisition terminal sheet and the second side surface of the acquisition notch; and
a cutting notch is provided in a middle of the connection strip and configured to cause the connection strip to break when the each of the cells contact sub-sheets is pulled.

10. The cells contact sheet according to claim 7, wherein the acquisition terminal sheet is provided with a buffer notch between the first end and the second end.

11. The cells contact sheet according to claim 1, wherein each of the cells contact sub-sheets has an edge connected with a bent terminal sheet configured to acquire a temperature signal of one of the cell groups corresponding to the each of the cells contact sub-sheets.

12. A cells contact system, comprising:
a holder;
a plurality of busbars arranged in parallel on the holder and configured to be respectively connected with a plurality of cell groups of a battery module; and
a cells contact sheet comprising:
a plurality of cells contact sub-sheets configured to acquire work signals of the plurality of cell groups, respectively; and
at least one connecting sheet being flexible and electrically conductive,
wherein each of the at least one connecting sheet is arranged between every two adjacent ones of the cells contact sub-sheets to connect the every two adjacent ones of the cells contact sub-sheets to each other; and
the each of the at least one connecting sheet is provided with a first bending structure configured to deform when two of the cell groups respectively corresponding to the every two adjacent ones of the cells contact sub-sheets move away from each other or close to each other,
wherein the plurality of cells contact sub-sheets are opposite to and connected with the plurality of busbars, respectively.

13. The cells contact system according to claim 12, wherein the each of the at least one connecting sheet further comprises a sheet body, and the first bending structure protrudes, relatively to the sheet body, toward the two of the cell groups.

14. The cells contact system according to claim 13, wherein the first bending structure has a first surface, and the first surface is in a middle of the first bending structure and faces the two of the cell groups; and
the first surface is parallel to each of the cells contact sub-sheets.

15. A battery pack, comprising:
a housing having a first accommodating cavity and a second accommodating cavity arranged in a longitudinal direction;
at least one battery module arranged in the first accommodating cavity, the battery module comprising a plurality of cell groups arranged in the longitudinal direction;
a battery management system board arranged in the second accommodating cavity; and
at least one cells contact system arranged in the first accommodating cavity,
wherein the cells contact system comprises:
a holder;
a plurality of busbars arranged in parallel on the holder and configured to be respectively connected with the plurality of cell groups; and
a cells contact sheet comprising:
a plurality of cells contact sub-sheets configured to acquire work signals of the plurality of cell groups, respectively; and
at least one connecting sheet being flexible and electrically conductive,
wherein each of the at least one connecting sheet is arranged between every two adjacent ones of the cells contact sub-sheets to connect the every two adjacent ones of the cells contact sub-sheets to each other; and
the each of the at least one connecting sheet is provided with a first bending structure configured to deform when two of the cell groups respectively corresponding to the every two adjacent ones of the cells contact sub-sheets move away from each other or close to each other,
wherein the plurality of cells contact sub-sheets are opposite to and connected with the plurality of busbars, respectively; and
wherein one of the cells contact sub-sheets is provided with a first signal output terminal connected to the battery management system board.

16. The battery pack according to claim 15, wherein the at least one battery module comprises a plurality of battery modules, and the at least one cells contact system comprises a plurality of cells contact systems respectively corresponding to the plurality of battery modules; and
the plurality of battery modules are sequentially arranged in a transverse direction perpendicular to the longitudinal direction.

17. The battery pack according to claim 16, wherein a longitudinal beam is arranged between every two adjacent ones of the plurality of battery modules and connected to an inner wall of the housing.

18. The battery pack according to claim 17, further comprising:
a battery energy distribution device arranged in the second accommodating cavity;
a battery charge and discharge interface arranged on a side of the housing away from the second accommodating cavity; and
a charge and discharge connection bar connecting the battery energy distribution device with the battery charge and discharge interface, the charge and discharge connection bar being arranged on a side of the longitudinal beam away from a bottom of the housing.

19. The battery pack according to claim 18, wherein the battery charge and discharge interface comprises a charge interface and a discharge interface;
the charge and discharge connection bar comprise a charge positive bar, a discharge positive bar, and a charge and discharge negative bar;
a positive port of the charge interface is connected with a positive port of the battery energy distribution device through the charge positive bar;
a positive port of the discharge interface is connected with the positive port of the battery energy distribution device through the discharge positive bar; and
both a negative port of the charge interface and a negative port of the discharge interface are connected with a negative port of the battery energy distribution device through the charge and discharge negative bar.

20. The battery pack according to claim 18, wherein the charge and discharge connection bar comprises a middle bar, and two end bars respectively connecting two ends of the middle bar with the battery energy distribution device and the battery charge and discharge interface; and
the two end bars are soft metal bars.
